(19) United States
(12) Patent Application Publication
(10) Pub. No.: US 2005/0033714 A1
(43) Pub. Date: Feb. 10, 2005

(54) Networked knowledge management and learning

(76) Inventor: Paul Guignard, Batemans Bay (AU)

Correspondence Address: GRAY, CARY, WARE & FREIDENRICH LLP, 2000 University Avenue, E. Palo Alto, CA, 94303-2248, US

(21) Appl. No.: 10/488,445

(22) PCT Filed: Sep. 3, 2002
(86) PCT No.: PCT/AU02/01195

(30) Foreign Application Priority Data
Sep. 3, 2001 (AU) PR 7415

(51) Int. Cl. G06N 3/08; G06F 15/18; G06N 5/04; G06F 17/00

(52) U.S. Cl. 706/61; 706/25

(57) ABSTRACT

This invention concerns a network server operable to run an application and communicate using question and answer sessions to provide answers to users questions. In particular it concerns such a server equipped to deal with the situation where it is unable to provide an answer from the application as it exists at that time. To do this the server initiates and controls a knowledge extending question and answer session to add the answer to the application. In a further aspect it concerns a method of operating such a server.

### TECHNICAL FIELD

This invention concerns a network server operable to run an application and communicate using question and answer sessions to provide answers to users questions. In particular it concerns such a server equipped to deal with the situation where it is unable to provide an answer from the application as it exists at that time. In a further aspect it concerns a method of operating such a server.

### BACKGROUND ART

A “Generic Knowledge Management System” (GKMS) is described in PCT/AU99/00501 and the “Intelligent Courseware Development and Delivery Environment”, (ICDDE) is described in Australian provisional patent application PR0090 and both of these specifications are incorporated herein by reference.

The processes or agents described in these patents run on servers and clients that can be connected to networks giving access to a variety of other clients and other servers. The server or client refers to the software environment that runs the server or client process respectively. An application (such as file system) or a certain task in an application can be a server process. A browser on a desktop can be a client process. The server or client processes can be installed on any machine, from mobile phones to mainframes, via personal digital assistants, notebooks, desktops, etc. It is also possible for a client to be a measuring device or transducer. Each of these machines can act as a server for some processes and as client for some other processes. It is also possible, and quite common, that the same machine acts both as a server and a client. This is particularly the case for people who give demonstrations; having the server and the client on the same machine makes them independent of any connection to any other network or device.

When information is communicated from servers to clients, and from clients to servers, the meaning of these exchanges depends on the processes in the server and the client that enable the GKMS and ICDDE processes to take place.
the users are not specifically informed, during use, of how the display is linked with the processes in the server and how the end-result, the display and the interaction, is achieved on the client under the control or instructions of the server;
in a similar way, the users are not specifically informed of how their input, when uploaded to the server, influence the operations of the server.

The commercial applications of this invention relate to most practical uses of systems based on the GKMS and ICDDE patents. The exchanges of information involved in running the processes make these processes possible and the commercial applications powerful.

### DISCLOSURE OF THE INVENTION

This invention concerns a network server operable to run an application and communicate using question and answer sessions to provide answers to users questions, where the application makes use of a knowledge base having: a problem context in which there are patterns of problem objects, a solution context in which there are patterns of solution objects, and mappings between problem patterns in the problem context and solution patterns in the solution context; and in which knowledge is defined by the mappings; and where the server is further operable in the event no pattern exists to give an answer to a question, to initiate a knowledge extending question and answer session in which an expert sets up new contexts and mappings to create an answer to that question.

The server may control the knowledge extending session to constrain the contexts and mappings to conform to server requirements.

The objects in both the problem and solution contexts may be arranged in hierarchies. They generally have a title, explanation and values such as properties and methods. The answers to questions may be provided by the explanation or values attached to the objects in the problem space, rather than mappings to patterns in the solution context.

The knowledge may be stored in a database.

In response to a question, a client may receive an answer or one or several further questions. A series of further questions may be issued by the server to enable a client to refine a question to the point where it can be associated with a pattern in the source context and therefore answered. Such questions are ordered dynamically according to their importance in searching the data, the information gained from the session so far, and the knowledge in the knowledge base.

A knowledge extending session may take place between the server and the same or another client.

In a further aspect this invention concerns a method of operating a server runing an application and communicating using question and answer sessions to provide answers to users questions, where the application makes use of a knowledge base having: a problem context in which there are patterns of problem objects; a solution context in which there are patterns of solution objects, and mappings between problem patterns in the problem context to solution patterns in the solution context; and in which knowledge is defined by the mappings; and, where no pattern exists to enable the server to give an answer to a question from a client, the method involving the step of: initiating a knowledge extending question and answer session in which an expert sets up new contexts and mappings to create an answer to that question.

### BRIEF DESCRIPTION OF THE DRAWINGS

FIG. 1 is a block diagram showing a generic network of client servers.

Examples of the invention will now be described with reference to the following drawings, in which:

FIG. 2 is a block diagram showing a network of client-servers running the GKMS or the ICDDE processes.

FIG. 3 is a diagram showing the implementation of GKMS or ICDDE processes in a network environment.

FIG. 4 is a screen shot of a problem context.

FIG. 5 is a screen shot of a problem context element.

FIG. 6 is a screen shot of a list of mappings.

FIG. 7 is a flowchart showing a GKMS process.

FIG. 8 is a block diagram showing a knowledge capture loop in GKMS.

FIG. 9 is a block diagram showing an expanded knowledge capture loop in an on the job problem solving system.

FIG. 10 is a screen shot of an example of a context definition in a client.

FIG. 11 is a screen shot of an example of a knowledge item definition in a client; FIG. 11a is a screenshot of the knowledge item.

FIG. 12 is a screen shot of an example of server output for a user during a consultation, displayed in a client.

FIG. 13 is a screen shot of an example of a knowledge item definition in a client; FIG. 13a is a screenshot of the knowledge item.

### BEST MODES OF THE INVENTION

Network Interactions

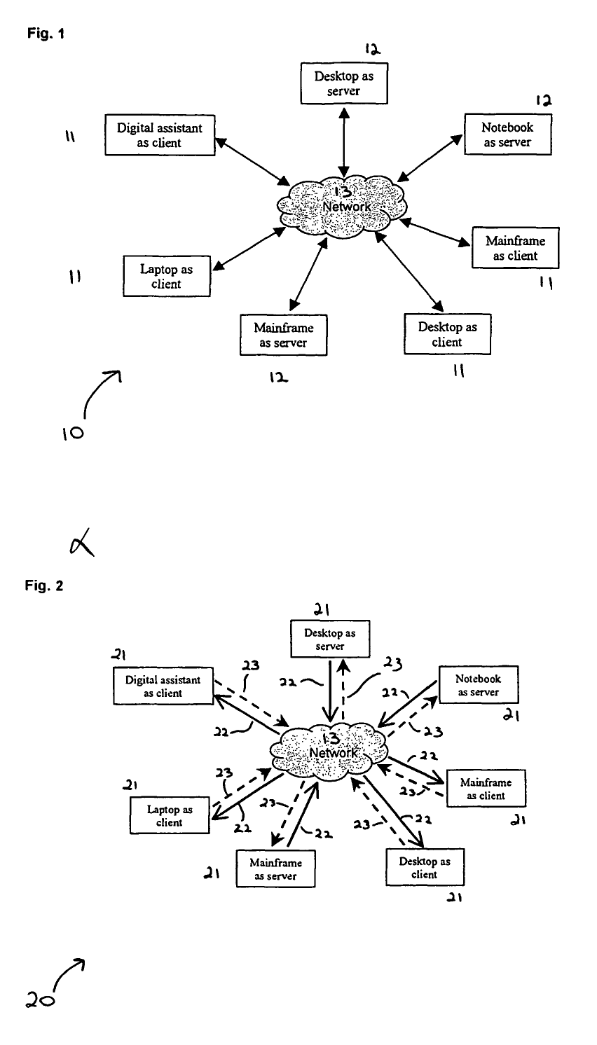

FIG. 1 illustrates a generic arrangement 10 of clients 11 and servers 12 linked by a network 13. The network 13 could be the Internet, and intranet, a local area network or any of these connected to another network.

FIG. 2 illustrates an arrangement 20 of client-servers 21 running the processes, such as those described in the GKMS and ICDDE patents, over a network 13. The client-servers 21 may operate as either servers or clients, depending on the process they may be sending as servers 22 and receiving from clients 23, or sending as clients and receiving as server. In GKMS and ICDDE, the inputs by users, whether they are experts, non-expert needing advice, learners or trainers, take place in the clients. The network 13 is an integral part of most GKMS and ICDDE environments.

The protocol for the exchanges is usually http and the data transferred are html files. Uploads to the server are performed using the standard Get Forms or Post Form in http. In the Get Form, the user input is appended to the URL sent to the server (and typically processed by a servlet on the server). Files from the server are decoded by the browser and displayed on the screen.

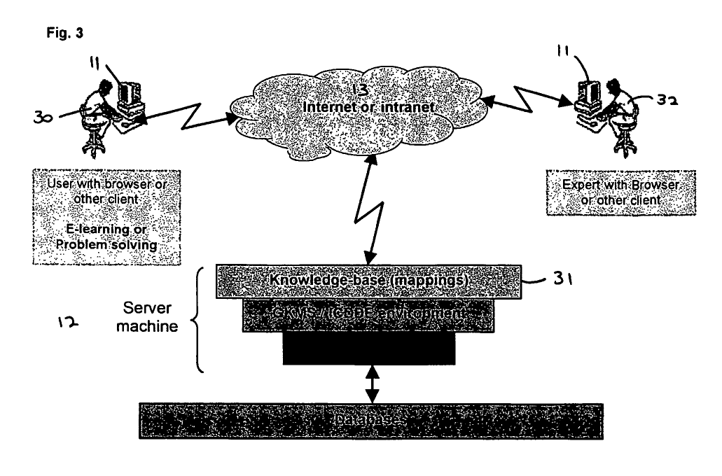

Referring now to FIG. 3, a first user 30, engaged in e-learning or problem solving, uses a browser 11 to access a server 12 via the Internet 13. Server 12 comprises a knowledge base 31 of the type having a problem context in which there are patterns of problem objects with the objects arranged in a hierarchy. It also has a solution context in which there are patterns of solutions objects, and those objects are also arranged in a hierarchy. The server also includes mappings between problem patterns in the problem context to the solutions patterns in the solution context, and these mappings define knowledge.

User 30 is in an interactive session with server 12 that is begun by logging on and providing authentication. The session will proceed on the basis of questions and answers, and is commenced by server 12 asking user 30 “What is your question?”.

In response the user submits a question or an answer to one or several questions submitted by the server. The server may respond in a number of different ways to the users question. First, the question from the user may be identified as being a problem object, or pattern of problem objects in the problem context. In this case the server may provide an answer from the knowledge base. This answer may be generated in two different ways, or a combination, information associated with one or more of the objects in the problem space may be displayed to the user to answer to the user's question. In an alternative a mapping is activated from the pattern of problem objects identified to a solution pattern and then displaying information associated with the solution pattern.

It is also possible that no answer can be given to the question currently asked, but that the server is able to generate questions to refine the user's question. In this case the server may respond with a preliminary answer and a request for further information. The user may then respond with a more precise question (in the form of further answers to questions from the server for example) in order to receive an answer.

This invention is also concerned with the situation where no answer is able to be provided to the user. In this situation the server will initiate a knowledge extending session with an expert 32. This expert will also communicate with the server 12 using a client 11 over the Internet 13. The expert may add a new object to the problem or solution context to answer the question, or they may vary an existing object. Alternatively, or in addition they may add a new mapping or vary an existing mapping. The processes for generating a new answer will now be described with reference to several particular examples.

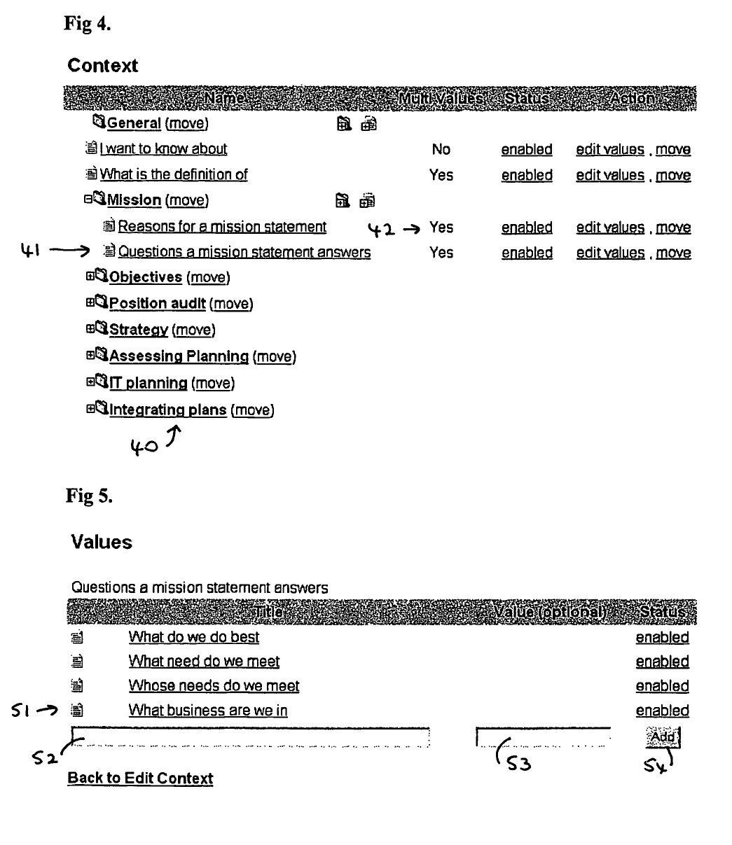

Referring to FIG. 4 a problem context can be seen to contain a hierarchical list of objects 40. One of the objects 41 is “questions a mission statement answers” and this seen at 42 to be a multi-valued object. The current values for this object are shown in FIG. 5, and they include the question 51 “What business are we in?”. Further titles and values can be added using the data entry boxes 52 and 53 and the add button 54. A table (not shown) is provided in which the value “What business are we in?” 51 is linked to the object “questions a mission statement answers” 41. By making changes in the table the values of the objects may be changed.

Note: To complete adding knowledge, a knowledge element would need to be added that uses, as part of its source pattern, the new value defined above. In a similar way, a new context attribute with values can be defined and used in new knowledge elements.

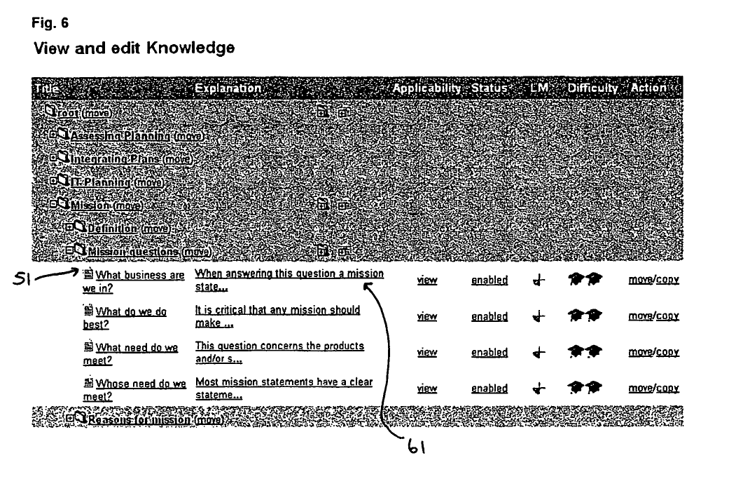

FIG. 6 shows a list of mappings in which some value titles such as the “What business are we in” title 51 can be seen to be associated with some explanation 61.

A session with a user may start with the server asking the question “What do you want to know about?” and offering a drop down box containing a list including “mission statements”. A user selecting this item from the list may then be presented with a piece of advice including some follow-on questions and further drop down boxes, such as the statement “questions a mission statement answers” and a drop down box containing the list shown in FIG. 5. A number of such questions may be posed simultaneously and depending upon the answers a range of further advice may be offered in a similar fashion. A user selecting the question “What business are we in?” 51 may be presented with some text providing an answer. This text being the explanation 61 attached to that question shown in FIG. 6 (and the previous questions in the consultation). In this example there is no solution space and the answer to the enquiry is provided by reference to the explanation associated with the question(s) in the problem space. In the screen where the answer is displayed to the user there may be a space for the user to enter comments, and the answer and comments may be saved by the user for future use.

GKMS Interactions

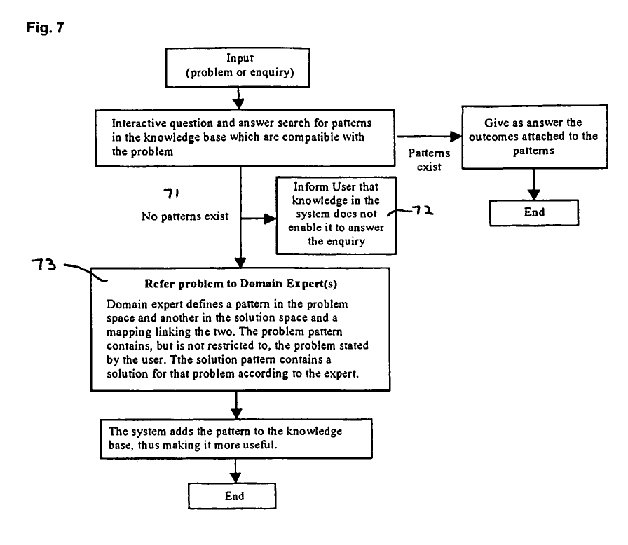

In the GKMS system similar operations take place, and these are illustrated in FIG. 7. It can occur in this system that no pattern may be found in the knowledge base that is compatible with the question 71.

In this case the user is informed that the server is unable to answer the enquiry 72.

The server then refers the problem to a domain expert 73, who may be another remote user. This domain expert addresses the problem by defining a pattern in the problem space, defining a pattern in the solution space, and defining a new mappings linking the new patterns. The system then adds the new material to the knowledge base 74. The problem pattern contains, but is not restricted to the problem stated by the user. The solution pattern contains a solution to that problem according to expert. The expert can also add new elements to the context as explained above to be able to define new mappings or knowledge that deal with new issues or problems.

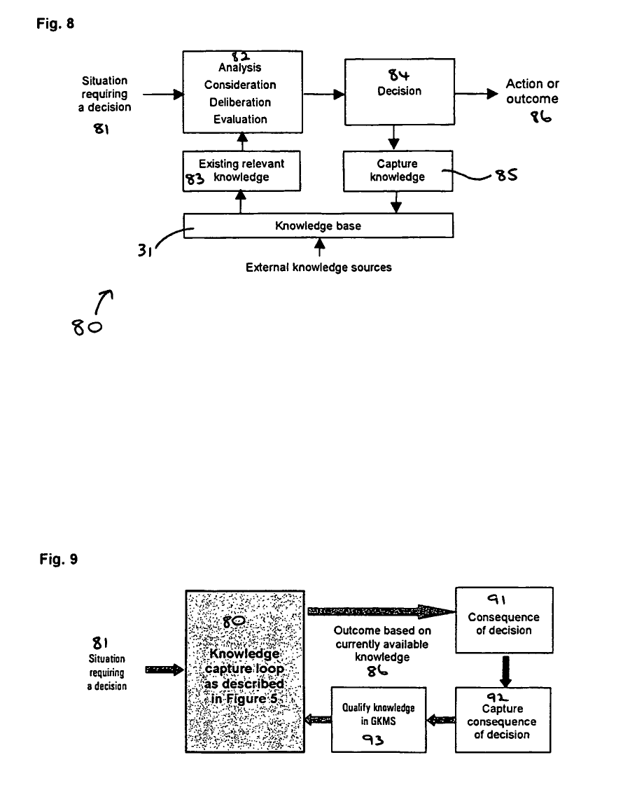

The knowledge capture loop is shown in greater detail in FIG. 8 which extends and complements FIG. 7. It illustrates the process that takes place in the server of a GKMS when it recieves a situation requiring a decision 81. First the situation is analysed 82, taking into account existing relevant knowledge from the knowledge base. Once the expert makes a decision 84 the new knowledge is captured 85 by the knowledge base in order to be able to answer the question in future. Sometimes the decision will cause the initiation of another consultation session 86.

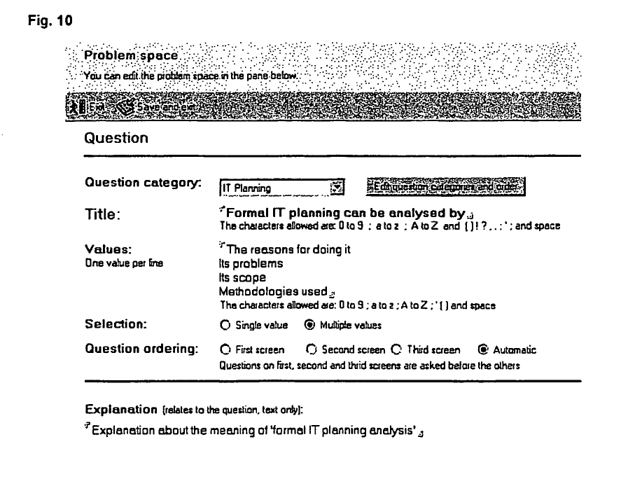

FIG. 9 is an extension of FIG. 8 in which the consequences 91 of the decision(s) taken by a GKMS are captured 92, evaluated and used to qualify 93 the knowledge in the GKMS. Once again it involves signal exchanges between servers and clients, and is controlled by the server.

Table 1 below lists a) the outputs of some GKMS server processes that instruct clients to produce the correct user interface, and b) the inputs by the client (usually but not exclusively a human using the client) that is sent to the server for processing. The processes considered refer to:
the definition and maintenance of the multidimensional source and destination spaces (the context space) for expressing mappings or knowledge,
the definition and maintenance of the mappings that express knowledge in the context space,
the question-answer session or consultation (the user can be an expert or someone needing access to knowledge in the system).

All these processes refer to interactions between a user (who can be an expert or someone needing access to knowledge or advice) and the GKMS or ICDDE. These processes can also refer to interactions between two GKMS systems in which case there is no human interaction.

Refer to the GKMS patent for a complete list of processes and their descriptions.

TABLE 1
GKMS processes on the server and the client

| Server or client process | |
|---|---|
| output | Explanation |
| Context definition and | Implements the GKMS model for context. |
| maintenance | Controlled by the GKMS server, guides the |
| | users or clients to conform to the GKMS |
| | requirements for context definition. The |
| | context is a hierarchy of objects each with a |
| | title, explanation, and values (properties and |
| | methods) |
| Mappings definition and | Implements the GKMS model for mappings |
| maintenance | as knowledge. |
| | Controlled by the GKMS server, guides the |
| | user to conform to the GKMS requirements |
| | for mappings definition. Each mapping |
| | contains a problem region in the problem |
| | space, a possible solution region in the |
| | solution space, and an explanation as to the |
| | nature of the knowledge. |
| Questions from the | Implements the GKMS model for |
| GKMS server to client(s) | consultation with users. |
| | Controlled by the GKMS server, uses the |
| | previous questions and answers to |
| | determine the next best questions and |
| | answers to arrive at the relevant advice as |
| | quickly as possible. Questions are ordered |
| | according to their importance in searching |
| | the database, determined using the |
| | information gained from the consultation so |
| | far and the knowledge in the knowledge |
| | base. |
| Instructions as to how to | Controlled by the GKMS server, adjust the |
| respond to the GKMS | instructions based on the display processed |
| server | by the server. |
| Advice from the GKMS | Controlled by the GKMS server, orders, |
| to the client(s) | describes and qualifies the advice given |
| | (advice and further questions can happen on |
| | the same screen during a consultation). |
| | The advice is grouped in ‘definite advice’ that |
| | is certified by an expert, and in ‘possibly |
| | relevant advice’ that may apply to the |
| | situation but is not certified by an expert. In |
| | each group, the knowledge items are |
| | grouped in module and or categories and |
| | they can be ordered according to specificity |
| | or relevance with respect to the enquiry. |
| Inputs or comments from | Response by the client(s) to the display by |
| the client to the GKMS | the server. |

ICDDE Interactions

The ICDDE builds on and extends the GKMS processes using the competency-based model for learning as explained in the patent PR0090.

FIG. 10 is a screen shot of a context definition in the problem space in this system.

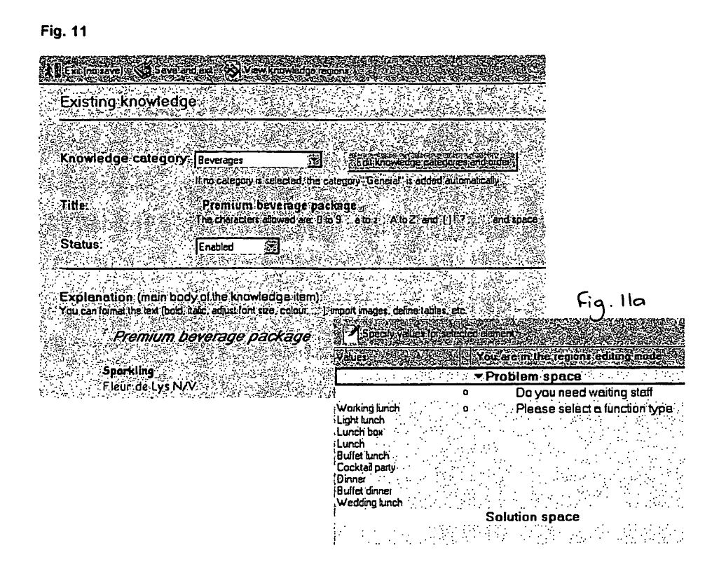

FIG. 11 is a screen shot of a knowledge item definition in a client. This item has a source region and an empty solution region as shown in FIG. 11a.

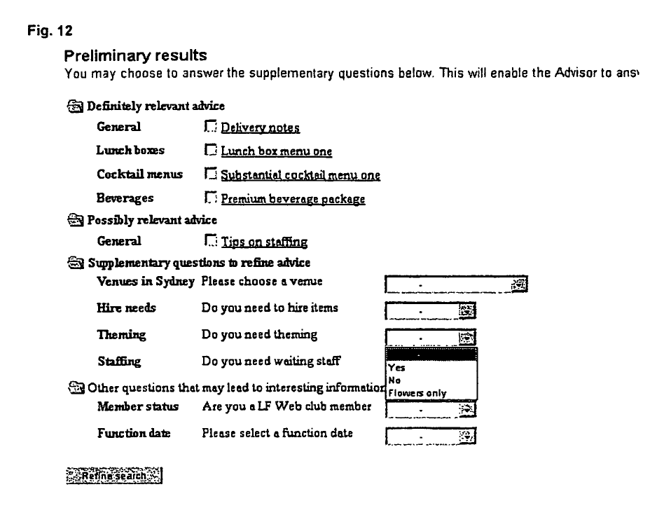

FIG. 12 is a screen shot of server output for a user during a consultation, as displayed in a client. It shows categorized and ordered advice and further question to refine the enquiry and associated search process.

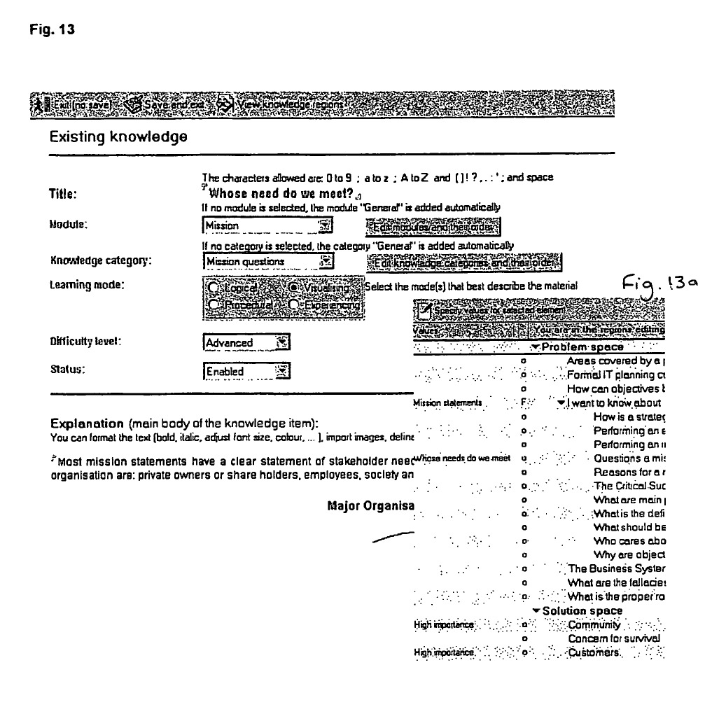

FIG. 13 is a screen shot of a knowledge item definition in a client. This knowledge item has a source region and a solution region, shown in FIG. 13a.

Table 2 lists a) the outputs of some ICDDE server processes that instruct clients to produce the correct user interface, and b) the inputs the client (usually a human using the client) that is sent to the server for processing. The processes considered refer to:
the definition and maintenance of the multidimensional situation and outcome spaces (the context space) for expressing the courseware elements (as mappings or knowledge),
the definition and maintenance of the mappings that express the courseware elements in the context space,
the learning session or consultation that takes place when a learner is using the system (the user can be an trainer or someone needing access to knowledge in the system).

All these processes refer to interactions between a user (who can be an trainer or someone needing access to knowledge or advice) and the ICDDE. These processes could also refer to interactions between two ICDDE systems in which case there is no human interaction.

Refer to the ICDDE patent for a complete list and description of these processes.

TABLE 2
ICDDE processes on the server and the client

| Server or client process | |
|---|---|
| output | Explanation |
| Context definition and | Implements the ICDDE model for context. |
| maintenance | Controlled by the ICDDE server, guides the |
| | users or clients to conform to the ICDDE |
| | requirements for context definition. |
| Mappings definition and | Implements the ICDDE model for mappings |
| maintenance | as knowledge. |
| | Controlled by the ICDDE server, guides the |
| | user to conform to the ICDDE requirements |
| | for mappings definition. |
| Courseware elements or | Implements the ICDDE model for a learning |
| advice or questions from | session with users. |
| the GKMS server to | Controlled by the ICDDE server, uses the |
| client(s) | previous inputs and actions of the client user |
| | to determine the next best display to support |
| | the learning or on-the-job problem-solving |
| | objectives. |
| Tests definition and | Implements the ICDDE model for tests. |
| maintenance | Controlled by the ICDDE server, guides the |
| | user to conform to the ICDDE requirements |
| | for tests definition. |
| Exercises and | Implements the ICDDE model for exercises |
| assignments definition | and assignments. |
| and maintenance | Controlled by the ICDDE server, guides the |
| | user to conform to the ICDDE requirements |
| | for exercises and assignments definition. |
| Learning mode | Implements the ICDDE model for the |
| questionnaire definition | learning mode questionnaire. |
| and maintenance | Controlled by the ICDDE server, guides the |
| | user to conform to the ICDDE requirements |
| | learning mode questionnaire. |
| Instructions as to how to | Controlled by the ICDDE server, adjust the |
| respond to the ICDDE | instructions for the display based on the |
| server | learning session so far. |
| Advice from the ICDDE to | Controlled by the ICDDE server, orders, |
| the client(s) | describes and qualifies the advice given |
| | (advice and further questions can happen on |
| | the same screen during a consultation). |
| Inputs or comments from | Response or action by the client(s) to the |
| the client to the ICDDE | display produced by the ICDDE server. |

The processes supported by the ICDDE are:
interactive discovery contents exploration smart indexes sequential learning
annotation of course elements
comments sent to lecturer
free text search
personal folder
statistics

A statistics view provides learners with a view of all their activities so far. It includes: number of course elements visited/not visited, number of elements needing attention, competency levels reached with dates, test tried and passed with dates, exercises and assignments tried and/or passed with dates. This information is available for every module or chapter in the courseware. In addition, learners can compare their results with the average of the students taking (or who have taken) the same courseware.

1. A network server operable to run an application and communicate using question and answer sessions to provide answers to users questions, where the application makes use of a knowledge base having: a problem context in which there are patterns of problem objects, a solution context in which there are patterns of solution objects, and mappings between problem patterns in the problem context and solution patterns in the solution context; and in which knowledge is defined by the mappings; and where the server is further operable in the event no pattern exists to give an answer to a question, to initiate a knowledge extending question and answer session in which an expert sets up new contexts and mappings to create an answer to that question.

2. A network server according to claim 1, where the server controls the knowledge extending session to constrain the contexts and mappings to conform to server requirements.

3. A network server according to claim 1 or 2, where the objects are arranged in a hierarchy.

4. A network according to claim 1, 2 or 3, where the objects in both the problem and solution contexts have a title, explanation and values.

5. A network server according to any preceding claim, where the answers to questions are provided by information associated with objects in the problem space.

6. A network server according to any preceding claim, where the knowledge is stored in a database.

7. A network server according to any preceding claim, where, in response to a question, a client receives a series of further questions from the server to enable a client to refine the question to the point where it can be answered.

8. A network server according to claim 7, where the further series of questions are ordered according to their importance in searching the data, the information gained from the session so far, and the knowledge in the knowledge base.

9. A network server according to any preceding claim, where a knowledge extending session takes place between the server and an expert client.

10. A method of operating a server runing an application and communicating using question and answer sessions to provide answers to users questions, where the application makes use of a knowledge base having: a problem context in which there are patterns of problem objects; a solution context in which there are patterns of solution objects, and mappings between problem patterns in the problem context to solution patterns in the solution context; and in which knowledge is defined by the mappings; and, where no pattern exists to enable the server to give an answer to a question from a client, the method involving the step of: initiating a knowledge extending question and answer session in which an expert sets up new contexts and mappings to create an answer to that question.

11. A method according to claim 10, where the server controls the knowledge extending session to constrain the contexts and mappings to conform to server requirements.

12. A method according to claim 10 or 11, where the server answers questions by providing information associated with objects in the problem space.

13. A method according to claim 10, 11 or 12, where, in response to a question, a client receives a series of further questions from the server to enable a client to refine the question to the point where it can be answered.

14. A method according to claim 13, where the further series of questions are ordered according to their importance in searching the data, the information gained from the session so far, and the knowledge in the knowledge base.

15. A method according to any one of claims 10 to 14, where a knowledge extending session takes place between the server and an expert client.
